(19) United States
(12) Patent Application Publication
(10) Pub. No.: US 2024/0236009 A1
(43) Pub. Date: Jul. 11, 2024

(54) TECHNIQUES FOR PACKET DATA CONVERGENCE PROTOCOL REORDERING WITHIN A TIMER

(71) Applicant: QUALCOMM Incorporated, San Diego, CA (US)

(72) Inventors: Arun Prasanth BALASUBRAMANIAN, San Diego, CA (US); Arnaud MEYLAN, San Diego, CA (US); Jason TAN, San Diego, CA (US); Shailesh MAHESHWARI, San Diego, CA (US)

(21) Appl. No.: 18/153,105

(22) Filed: Jan. 11, 2023

(51) Int. Cl. H04L 47/34; H04L 47/28; H04W 28/10

(52) U.S. Cl. CPC H04L 47/34; H04L 47/28; H04W 28/10

(57) ABSTRACT

Various aspects of the present disclosure generally relate to wireless communication. In some aspects, a receiver device may receive a first packet of a plurality of packets included in a reordering window of the receiver device. The receiver device may receive a second packet of the plurality of packets. The receiver device may provide the first packet and the second packet based at least in part on expiration of a reordering timer. The receiver device may receive a third packet of the plurality of packets at a third time, wherein the first packet, the second packet, and the third packet are received sequentially. The receiver device may provide a set of packets including the first packet, the third packet, and the second packet in order, to a higher layer in accordance with a timer that is shorter than a length of the reordering window. Numerous other aspects are described.

### FIELD OF THE DISCLOSURE

Aspects of the present disclosure generally relate to wireless communication and to techniques and apparatuses for packet data convergence protocol (PDCP) ordering.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a receiver device. The method may include receiving a first packet of a plurality of packets at a first time, wherein the first packet has a first sequence number. The method may include receiving a second packet of the plurality of packets at a second time, wherein a third packet of the plurality of packets, to be received between the first packet and the second packed based at least in part on a third sequence number of the third packet, has not arrived at the second time. The method may include starting a timer based at least in part on the third packet having not arrived at the second time. The method may include receiving the third packet of the plurality of packets at a third time after the second time. The method may include providing the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

Some aspects described herein relate to a method of wireless communication performed by a receiver device. The method may include receiving a first packet of a set of packets at a first time, the first packet having a first sequence number, wherein the set of packets is associated with a respective set of sequence numbers including a highest sequence number and the receiver device is configured for in-order delivery of packets. The method may include receiving a second packet of the set of packets at a second time, the second packet having a second sequence number; and providing the first packet and the second packet based at least in part on expiration of a reordering timer. The method may include receiving a third packet of the set of packets at a third time, the third packet having a third sequence number that is between the first sequence number and the second sequence number, and wherein the third packet is received within a threshold range of the highest sequence number. The method may include providing the third packet based at least in part on the third packet being received within the threshold range of the highest sequence number.

Some aspects described herein relate to a receiver device for wireless communication. The receiver device may include a memory and one or more processors coupled to the memory. The one or more processors may be configured to receive a first packet of a plurality of packets at a first time, wherein the first packet has a first sequence number. The one or more processors may be configured to receive a second packet of the plurality of packets at a second time, wherein a third packet of the plurality of packets, to be received between the first packet and the second packed based at least in part on a third sequence number of the third packet, has not arrived at the second time. The one or more processors may be configured to start a timer based at least in part on the third packet having not arrived at the second time. The one or more processors may be configured to receive the third packet of the plurality of packets at a third time after the second time. The one or more processors may be configured to provide the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

Some aspects described herein relate to a receiver device for wireless communication. The receiver device may include a memory and one or more processors coupled to the memory. The one or more processors may be configured to receive a first packet of a set of packets at a first time, the first packet having a first sequence number, wherein the set of packets is associated with a respective set of sequence numbers including a highest sequence number and the receiver device is configured for in-order delivery of packets. The one or more processors may be configured to receive a second packet of the set of packets at a second time, the second packet having a second sequence number; and to provide the first packet and the second packet based at least in part on expiration of a reordering timer. The one or more processors may be configured to receive a third packet of the set of packets at a third time, the third packet having a third sequence number that is between the first sequence number and the second sequence number, and wherein the third packet is received within a threshold range of the highest sequence number. The one or more processors may be configured to provide the third packet based at least in part on the third packet being received within the threshold range of the highest sequence number.

Some aspects described herein relate to a non-transitory computer-readable medium that stores a set of instructions for wireless communication by a receiver device. The set of instructions, when executed by one or more processors of the receiver device, may cause the receiver device to receive a first packet of a plurality of packets at a first time, wherein the first packet has a first sequence number. The set of instructions, when executed by one or more processors of the receiver device, may cause the receiver device to receive a second packet of the plurality of packets at a second time, wherein a third packet of the plurality of packets, to be received between the first packet and the second packed based at least in part on a third sequence number of the third packet, has not arrived at the second time. The set of instructions, when executed by one or more processors of the receiver device, may cause the receiver device to start a timer based at least in part on the third packet having not arrived at the second time. The set of instructions, when executed by one or more processors of the receiver device, may cause the receiver device to receive the third packet of the plurality of packets at a third time after the second time. The set of instructions, when executed by one or more processors of the receiver device, may cause the receiver device to provide the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

Some aspects described herein relate to a non-transitory computer-readable medium that stores a set of instructions for wireless communication by a receiver device. The set of instructions, when executed by one or more processors of the receiver device, may cause the receiver device to receive a first packet of a set of packets at a first time, the first packet having a first sequence number, wherein the set of packets is associated with a respective set of sequence numbers including a highest sequence number and the receiver device is configured for in-order delivery of packets. The set of instructions, when executed by one or more processors of the receiver device, may cause the receiver device to receive a second packet of the set of packets at a second time, the second packet having a second sequence number. The set of instructions, when executed by one or more processors of the receiver device, may cause the receiver device to provide the first packet and the second packet based at least in part on expiration of a reordering timer. The set of instructions, when executed by one or more processors of the receiver device, may cause the receiver device to receive a third packet of the set of packets at a third time, the third packet having a third sequence number that is between the first sequence number and the second sequence number, and wherein the third packet is received within a threshold range of the highest sequence number. The set of instructions, when executed by one or more processors of the receiver device, may cause the receiver device to provide the third packet based at least in part on the third packet being received within the threshold range of the highest sequence number.

Some aspects described herein relate to an apparatus. The apparatus may include means for receiving a first packet of a plurality of packets at a first time, wherein the first packet has a first sequence number. The apparatus may include means for receiving a second packet of the plurality of packets at a second time, wherein a third packet of the plurality of packets, to be received between the first packet and the second packed based at least in part on a third sequence number of the third packet, has not arrived at the second time. The apparatus may include means for starting a timer based at least in part on the third packet having not arrived at the second time. The apparatus may include means for receiving the third packet of the plurality of packets at a third time after the second time. The apparatus may include means for providing the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

Some aspects described herein relate to an apparatus for wireless communication. The apparatus may include means for receiving a first packet of a set of packets at a first time, the first packet having a first sequence number, wherein the set of packets is associated with a respective set of sequence numbers including a highest sequence number and the receiver device is configured for in-order delivery of packets. The apparatus may include means for receiving a second packet of the set of packets at a second time, the second packet having a second sequence number. The apparatus may include means for providing the first packet and the second packet based at least in part on expiration of a reordering timer. The apparatus may include means for receiving a third packet of the set of packets at a third time, the third packet having a third sequence number that is between the first sequence number and the second sequence number, and wherein the third packet is received within a threshold range of the highest sequence number. The apparatus may include means for providing the third packet based at least in part on the third packet being received within the threshold range of the highest sequence number.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIGS. 4A and 4B are diagrams illustrating an example of a user plane protocol stack (in FIG. 4A) and a control plane protocol stack (in FIG. 4B) for a network node and a core network in communication with a UE, in accordance with the present disclosure.

FIG. 5 is a diagram illustrating an example of signaling associated with provision of packets in accordance with a threshold range, in accordance with the present disclosure.

FIG. 6 is a diagram illustrating an example of packet data convergence protocol (PDCP) reordering based on a reordering window and a timer, in accordance with the present disclosure.

FIG. 7 is a diagram illustrating an example process performed, for example, by a receiver device, in accordance with the present disclosure.

FIG. 8 is a diagram illustrating an example process performed, for example, by a receiver device, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

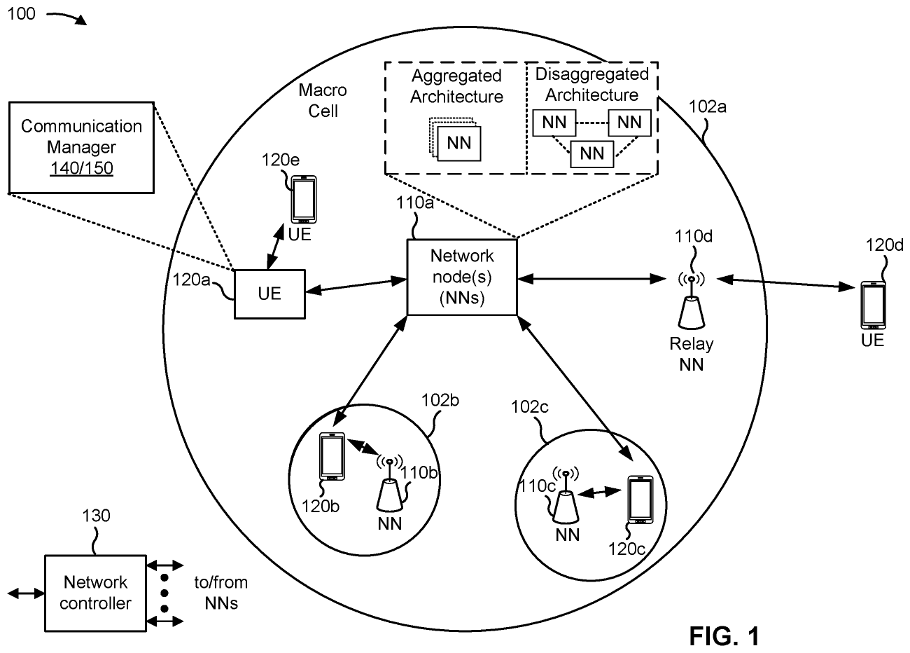

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a receiver device (e.g., UE 120 or network node 110) may include a communication manager 140. As described in more detail elsewhere herein, the communication manager 140 may receive a first packet of a plurality of packets at a first time, wherein the first packet has a first sequence number; receive a second packet of the plurality of packets at a second time, wherein a third packet of the plurality of packets, to be received between the first packet and the second packed based at least in part on a third sequence number of the third packet, has not arrived at the second time; start a timer based at least in part on the third packet having not arrived at the second time; receive the third packet of the plurality of packets at a third time after the second time; and provide the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer. Additionally, or alternatively, the communication manager 140 may perform one or more other operations described herein.

In some aspects, the receiver device may include a communication manager 150. As described in more detail elsewhere herein, the communication manager 150 may receive a first packet of a set of packets at a first time, the first packet having a first sequence number, wherein the set of packets is associated with a respective set of sequence numbers including a highest sequence number and the receiver device is configured for in-order delivery of packets; receive a second packet of the set of packets at a second time, the second packet having a second sequence number; receive a third packet of the set of packets at a third time, the third packet having a third sequence number that is between the first sequence number and the second sequence number, and wherein the third packet is received within a threshold range of the highest sequence number; and provide the third packet based at least in part on the third packet being received within the threshold range of the highest sequence number. Additionally, or alternatively, the communication manager 150 may perform one or more other operations described herein.

As indicated above, FIG. 1 is provided as an example. Other examples may differ from what is described with regard to FIG. 1.

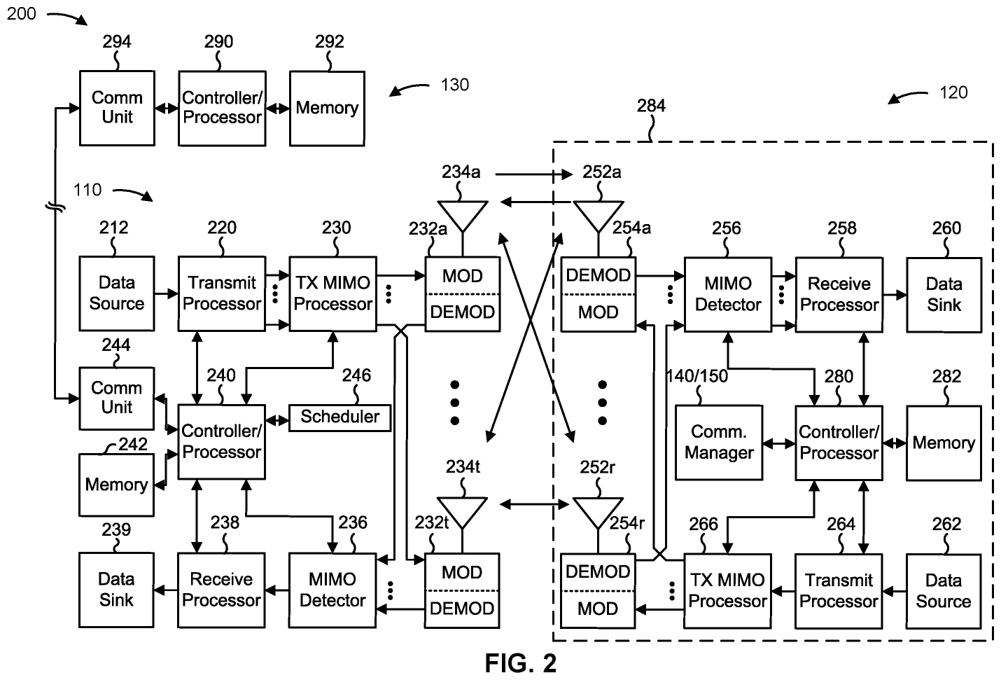

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

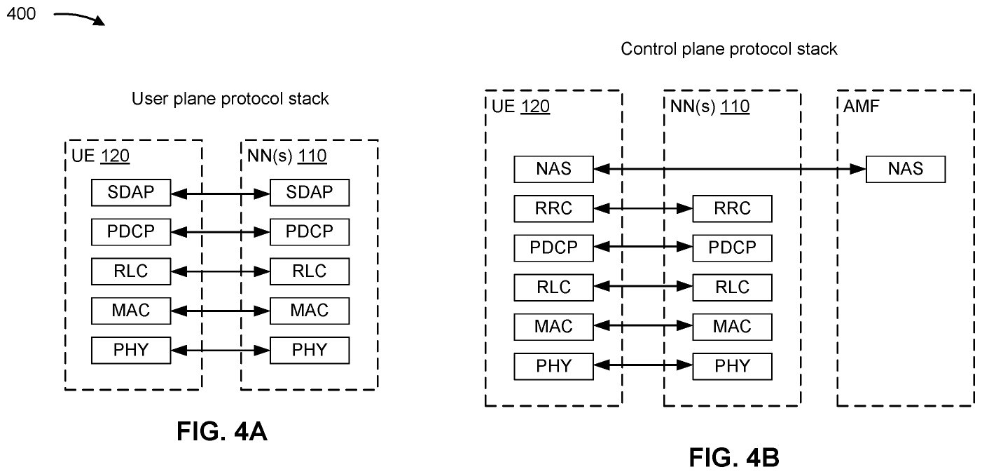

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-10).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-10).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

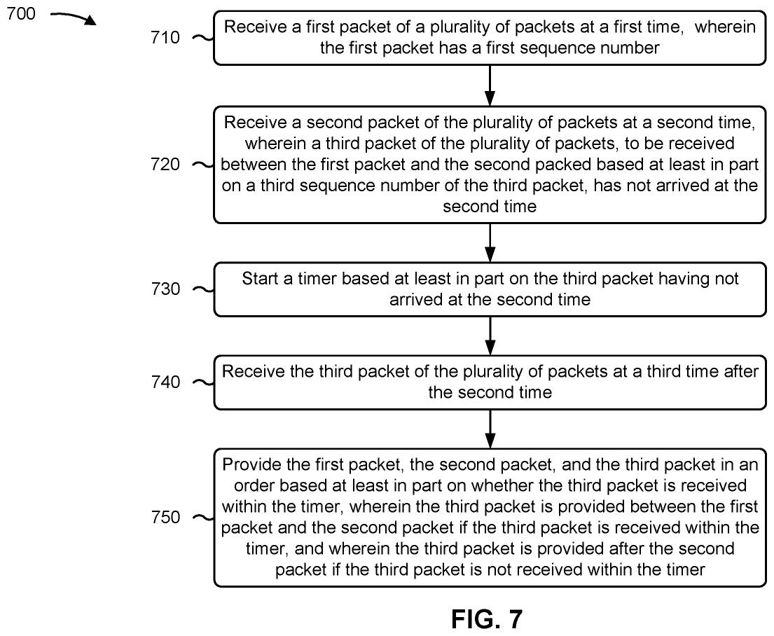

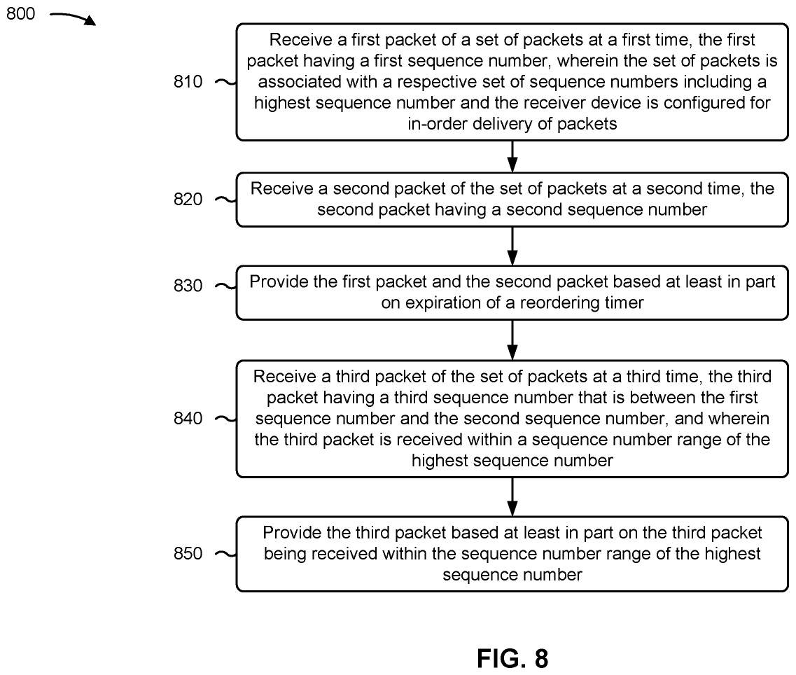

The controller/processor 240 of the network node 110, the controller/processor 280 of the UE 120, or any other component(s) of FIG. 2 may perform one or more techniques associated with PDCP reordering, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a receiver device includes means for receiving a first packet of a plurality of packets at a first time, wherein the plurality of packets are included in a reordering window of the receiver device apparatus and wherein the first packet has a first sequence number; means for receiving a second packet of the plurality of packets at a second time, wherein a third packet of the plurality of packets, to be received between the first packet and the second packed based at least in part on a third sequence number of the third packet, has not arrived at the second time; means for starting a timer based at least in part on the third packet having not arrived at the second time; means for receiving the third packet of the plurality of packets at a third time after the second time; and means for providing the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer. In some aspects, the means for the receiver device to perform operations described herein may include, for example, one or more of communication manager 140, antenna 252, modem 254, MIMO detector 256, receive processor 258, transmit processor 264, TX MIMO processor 266, controller/processor 280, memory 282, controller/processor 240, receive processor 238, antenna 234, and/or the like.

In some aspects, the receiver device includes means for receiving a first packet of a set of packets at a first time, the first packet having a first sequence number, wherein the set of packets is associated with a respective set of sequence numbers including a highest sequence number and the receiver device is configured for in-order delivery of packets; means for receiving a second packet of the set of packets at a second time, the second packet having a second sequence number; means for receiving a third packet of the set of packets at a third time, the third packet having a third sequence number that is between the first sequence number and the second sequence number, and wherein the third packet is received within a threshold range of the highest sequence number; and/or means for providing the third packet based at least in part on the third packet being received within the threshold range of the highest sequence number. In some aspects, the means for the receiver device to perform operations described herein may include, for example, one or more of communication manager 150, antenna 252, modem 254, MIMO detector 256, receive processor 258, transmit processor 264, TX MIMO processor 266, controller/processor 280, memory 282, controller/processor 240, receive processor 238, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

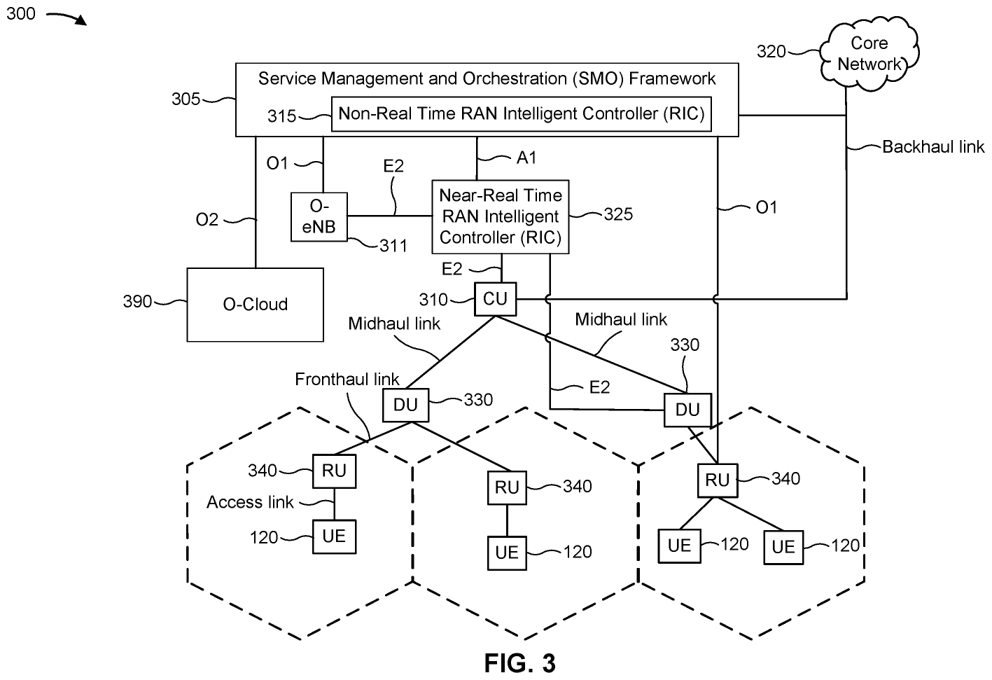

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIGS. 4A and 4B are diagrams illustrating an example 400 of a user plane protocol stack (in FIG. 4A) and a control plane protocol stack (in FIG. 4B) for a network node 110 and a core network in communication with a UE 120, in accordance with the present disclosure.

On the user plane, the UE 120 and the network node 110 may include respective PHY layers, MAC layers, RLC layers, PDCP layers, and SDAP layers. A user plane function may handle transport of user data between the UE 120 and the network node 110. On the control plane, the UE 120 and the network node 110 may include respective radio resource control (RRC) layers. Furthermore, the UE 120 may include a non-access stratum (NAS) layer in communication with an NAS layer of an access and management mobility function (AMF). The AMF may be associated with a core network associated with the network node 110, such as a 5G core network (5GC) or a next-generation radio access network (NG-RAN). A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 4, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

The RLC layer can operate in an AM, an unacknowledged mode (UM), or a transparent mode (TM). In AM, buffering is performed at the transmitter and the receiver. Segmentation is performed at the transmitter and reassembly is performed at the receiver. A feedback mechanism (including an acknowledgment (ACK) or a negative ACK (NACK)) is used for communication (such as RLC PDUs or RLC SDUs). AM may be used for certain signaling radio bearers (such as SRB1, SRB2, and SRB3) and data radio bearers. A sequence number in AM, which may be used for reassembly and recovery, can be selected from a 12-bit size or an 18-bit size. In UM, buffering is performed at the transmitter and the receiver, segmentation is performed at the transmitter, reassembly is performed at the receiver, and no feedback mechanism is used. In TM, no RLC header is used, buffering is performed at the transmitter only, no segmentation or reassembly is performed, and no feedback mechanism is used.

An RLC transmitter in AM may perform segmentation and concatenation of a packet. The RLC transmitter may add an RLC header to the packet. The RLC transmitter may provide an RLC PDU with the RLC header to the MAC layer. The RLC transmitter may also buffer the RLC PDU in case of a NACK from the RLC receiver. If the RLC transmitter receives a NACK within a period of time, then the RLC transmitter may trigger retransmission of the buffered RLC PDU.

The RLC transmitter may use a transmit window to limit the number of RLC SDUs that are transmitted while waiting for an acknowledgment from an RLC receiver. The transmit window may start at the oldest transmitted RLC SDU which has not been fully acknowledged. The oldest transmitted RLC SDU may have been partly acknowledged if it was segmented prior to transmission. The transmit window advances as acknowledgments are received. The size of the transmit window is limited by the sequence number (SN) range. The transmit window is used to prevent SN ambiguity at the RLC receiver. The length of the SN is configured using an RRC parameter.

The RLC transmitter can request a status report from an RLC receiver, such as based at least in part on a number of PDUs transmitted since a previous request, or a data volume since a previous request. An RLC parameter pollPDU may indicate the number of PDUs transmitted since a previous request, and an RLC parameter pollByte may indicate the data volume since the previous request. If the RLC transmitter requests and does not receive a status report after waiting a period of time defined by an RLC parameter t-PollRetransmit, the RLC transmitter may retransmit the request. The status report may identify the SNs up to which all RLC SDUs have been successfully received, with the exception of RLC SDUs specified within the remainder of the status report. The status report may indicate to retransmit a complete RLC SDU, or may indicate to retransmit one or more segments of an RLC SDU.

An RLC receiver in AM may buffer a received RLC PDU (referred to as an AM data (AMD) PDU) if the RLC PDU is within a receive window, perform reordering, remove the RLC header, and perform reassembly of RLC PDUs to form RLC SDUs. In AM, the RLC receiver may provide feedback regarding reception of RLC PDUs. In AM, each RLC PDU may be transmitted with an SN in ascending order. AM supports ARQ. The RLC receiver may transmit a status PDU (sometimes referred to as a status message or a status report) to indicate the status of RLC PDUs at the RLC receiver. The status PDU may indicate which RLC PDU SN(s) were not received by the RLC receiver. For example, the RLC receiver may use a reassembly timer (defined by an RLC parameter t-reassembly). The RLC receiver may start the reassembly timer when a segment of an SDU is received and more segments are pending for that SDU (e.g., if one or more SNs of the SDU are missed). Once the SDU is completely received, the RLC receiver may stop the reassembly timer. If the reassembly timer expires without having received the one or more SNs that were missed, the RLC receiver may transmit a status report indicating one or more segments of the SDU that were not received. For example, the RLC receiver may wait for the length of the reassembly timer (in the hope that a HARQ mechanism can provide for recovery via retransmission of the one or more SNs that were missed) before transmitting the status report to trigger RLC-layer retransmission of the one or more SNs that were missed.

As indicated above, FIGS. 4A and 4B are provided as one or more examples. Other examples may differ from what is described with regard to FIGS. 4A and 4B.

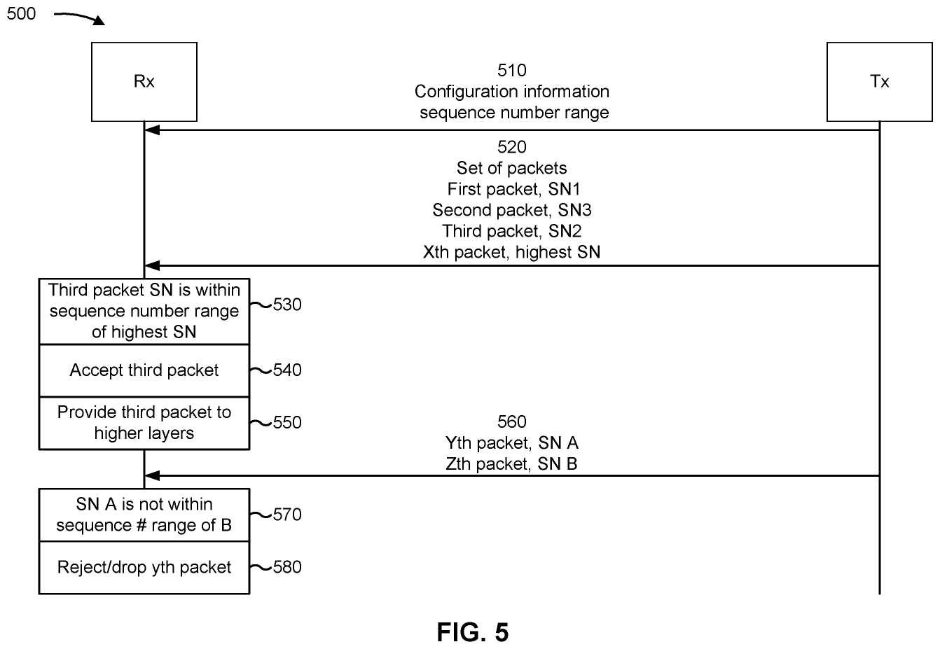

FIG. 5 is a diagram illustrating an example 500 of signaling associated with provision of packets in accordance with a threshold range, in accordance with the present disclosure. Example 500 includes a transmitter device (e.g., UE 120, network node 110) (shown as “Tx”) and a receiver device (e.g., UE 120, network node 110) (shown as “Rx”). In example 500, the transmitter device (which may include a PDCP transmitter or an RLC transmitter) may transmit a set of packets received and processed by the receiver device.

The PDCP of a transmitter device or a receiver device may perform various functions, including transfer of data, header compression/decompression, ciphering/deciphering, integrity protection and verification, timer based SDU discard, routing, duplication, reordering and in-order delivery, and/or out-of-order delivery. A transmitter device may apply sequence numbers to a set of packets (e.g., payloads, data blocks) a set of PDCP SDUs before adding headers to PDCP SDUs to generate PDCP PDUs. The PDCP PDUs (after further processing) may be transmitted to a receiver device. The receiver device may extract the packets from the PDCP PDUs.

In some examples, the receiver device may perform reordering and in-order delivery for PDCP PDUs. Reordering is based on the sequence numbers assigned by the transmitter device. The receiver device may detect a hole, which is a set of (one or more) skipped sequence numbers among a set of received packets. The set of skipped sequence numbers may indicate that a set of corresponding packets either have not arrived or have arrived out of order with respect to other packets. Based on detecting the set of skipped sequence numbers, the receiver device may trigger a reordering timer. The reordering timer may have a configurable length, which may be configured based on, among other concerns, a subcarrier spacing of a carrier on which the PDCP PDUs are received. The reordering timer may be used to determine a reordering window (though the reordering window can be based on or modified by factors other than the reordering timer). For in-order delivery of PDCP PDUs, the receiver device may buffer received traffic during the reordering window. If the receiver device receives packets having the set of skipped sequence numbers in the reordering window, the receiver device may reorder packets received in the reordering window such that sequence numbers of the packets are in order (e.g., ascending order), and may provide (e.g., deliver) the reordered packets to higher layers of the UE. If the receiver device reaches the end of the reordering timer without having received the packets associated with the out-of-order set of sequence numbers, the receiver device may provide all received packets to the higher layers in an order indicated by the set of sequence numbers (minus any unreceived packets). After the reordering timer ends, the receiver device may move the reordering window forward such that a second instance of the reordering window begins at a sequence number position at which a first instance of the reordering window ended. The receiver device may then discard any received packets with sequence numbers lower than a lowest sequence number of the second instance of the reordering window.

In some examples, the receiver device may perform out-of-order delivery for PDCP PDUs. In out-of-order delivery, the receiver device may not perform reordering according to a reordering timer. In out-of-order delivery, the receiver device provides received packets to higher layers in an order in which the packets are received. Out-of-order delivery may provide improved latency relative to in-order delivery, but may impact congestion control for traffic, as described elsewhere herein. In out-of-order delivery, the reordering timer may control whether the receiver device accepts (e.g., provides to higher layers) packets based on sequence numbers of the packets. For example, the UE may start a timer (referred to as a reordering timer, though the receiving device does not perform reordering for out-of-order delivery) defining a window that starts at a first sequence number and ends at a highest sequence number. If a packet received within the window has a sequence number higher than the first sequence number, then the packet is accepted and provided to higher layers. If the packet's sequence number is lower than the first sequence number, then the packet is rejected. Thus, the reordering timer in out-of-order delivery defines a window in which packets having a sequence number within a range of sequence numbers included in the window are accepted, and packets outside of this range are rejected (e.g., not provided to higher layers, dropped). In the case of out-of-order delivery, although no reordering is expected to take place, the PDCP reordering timer (t-reordering) is still used to move the window forward (as indicated by an RX_DELIV parameter) so that the PDCP layer does not keep accepting older packets and a correct COUNT can be calculated based on the latest hyper frame number (HFN) derived from RX_DELIV.

As mentioned, after the reordering timer expires, the window moves (both in the case of in-order delivery and for out-of-order delivery), and any packet with a sequence number earlier than (e.g., lower than) a lowest sequence number included in the window is discarded as received outside of an earlier instance of the window. Thus, management of the window is timer-based when holes in received sequence number are present. However, management of the window using the reordering timer may prevent a higher layer (e.g., application) from receiving a packet that could have been useful, for instance, for a file download. For example, a packet with sequence number 49 received during a window including sequence numbers 51-100 may be useful to complete a file download, but may be discarded since sequence number 49 is below sequence numbers 51-100. This may cause latency, decreased throughput, and interruptions to data transfers.

Some techniques described herein define a window in which packets are accepted by reference to a highest received sequence number or highest delivered sequence number (e.g., delivered to a higher layer) and using a threshold range. The threshold range may be defined, for example, by a constant. The threshold range may indicate a range of sequence numbers, lower than the highest received sequence number or lower than the highest delivered sequence number. If a packet is received, prior to a packet with the highest sequence number, with a sequence number included in the range of sequence numbers, the packet may be accepted and provided to higher layers, resulting in an out of order delivery. Once a packet with a sequence number higher than the highest sequence number is received or delivered, the sequence number may be measured relative to the packet with the sequence number higher than the highest sequence number. Thus, the window moves with a highest received (or delivered) sequence number rather than according to the expiration of a timer, which reduces the occurrence of dropped packets due to an arbitrary end of a window, thereby reducing latency, improving throughput, and reducing interruption to data transfers.

As shown in FIG. 5, and by reference number 510, in some aspects, the receiver device may receive (e.g., from the transmitter device or another entity), configuration information. In some aspects the configuration information may include a configuration for PDCP reordering. In some aspects, the configuration information may indicate that delivery of out-of-order packets received within a threshold range of a highest sequence number is enabled. For example, the configuration information may enable delivery of out-of-order packets after a long delay. In some aspects, the configuration information may indicate a threshold range. For example, the configuration information may indicate a number of packets defining the threshold range. In this example, the receiver device may use the number of packets by counting back from a highest sequence number (e.g., from a packet having the highest sequence number), by the number of packets, to identify a packet with a lowest sequence number included in the threshold range. In some aspects, the configuration information may indicate the threshold range using a constant. In this example, the receiver device may subtract the constant from the highest sequence number to identify a lowest sequence number included in the threshold range. If a sequence number of a received packet is within this threshold range, the receiver device may accept and provide the corresponding packet to higher layers.

In some aspects, the threshold range may be configured relative to a length of a reordering window of the receiver device. For example, the threshold range may be configured such that the threshold range includes a quarter of the reordering window or an eighth of the reordering window, among other examples.

As shown by reference number 520, the receiver device may receive a set of packets (e.g., a plurality of packets). The set of packets may include a first packet with an SN1 (received at a first time), a second packet with an SN3 (received at a second time after the first time), and a third packet with an SN2 (received at a third time after the second time). Thus, a hole occurs between the first packet and the second packet, meaning that the first packet, the second packet, and the third packet are out of order. The sequence numbers of the set of packets indicate that the correct order is: first packet, third packet, second packet. Furthermore, the set of packets includes an Xth packet, which is a most recently received packet and associated with a highest SN. Thus, the threshold range of the receiver device is measured from the highest SN.

As shown by reference number 530, the receiver device may determine that the third packet's SN (e.g., SN2) is within the threshold range of the highest SN. For example, the receiver device may determine that the third packet's SN is higher than a lowest SN included in the threshold range. As shown by reference number 540, the receiver device may accept the third packet. For example, the receiver device may accept (e.g., may not drop, may not discard, may buffer, may process) the third packet due to the third packet's SN being within the threshold range of the highest SN. As shown by reference number 550, the receiver device may provide the third packet to one or more higher layers (e.g., an Internet Protocol layer, an RRC layer, a SDAP layer, an application layer). Thus, the receiver device may accept and provide a packet based on the packet's SN being within a threshold range of a highest sequence number received by the receiver device.

As shown by reference number 560, the transmitter device may transmit, and the receiver device may receive, at least a Yth packet and a Zth packet. The Yth packet may have an SN A which is out of order with regard to one or more other packets, and the Zth packet may have an SN B. SN B is a highest SN received by the receiver device as of the transmission shown by reference number 560. Therefore, as shown by reference number 570, the receiver device may determine whether to accept SN A (of the Yth packet) and provide SN A to one or more higher layers based on whether SN A is within the threshold range of SN B (of the Zth packet). In example 500, SN A is not within the threshold range of SN B (of the Zth packet), indicating that SN A was received at least a threshold length of time before the arrival of the Zth packet. Therefore, as shown by reference number 580, the receiver device may reject (e.g., drop, cancel) the Yth packet.

As indicated above, FIG. 5 is provided as an example. Other examples may differ from what is described with regard to FIG. 5.

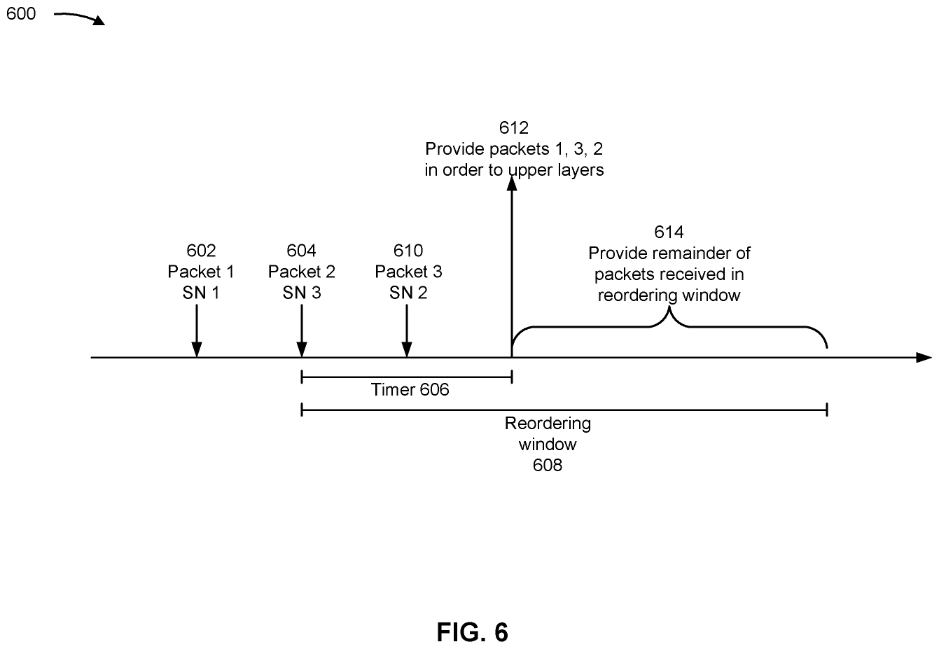

FIG. 6 is a diagram illustrating an example 600 of PDCP reordering based on a reordering window and a timer, in accordance with the present disclosure. In example 600, downward arrows indicate receptions by a receiver device (e.g., UE 120, network node 110).

The PDCP of a transmitter device or a receiver device may perform various functions, including transfer of data, header compression/decompression, ciphering/deciphering, integrity protection and verification, timer based SDU discard, routing, duplication, reordering and in-order delivery, and/or out-of-order delivery. A transmitter device may apply sequence numbers to a set of packets (e.g., payloads, data blocks) a set of PDCP SDUs before adding headers to PDCP SDUs to generate PDCP PDUs. The PDCP PDUs (after further processing) may be transmitted to a receiver device. The receiver device may extract the packets from the PDCP PDUs.

In some examples, the receiver device may perform reordering and in-order delivery for PDCP PDUs. Reordering is based on the sequence numbers assigned by the transmitter device. The receiver device may detect a hole, which is a set of (one or more) skipped sequence numbers among a set of received packets. The set of skipped sequence numbers may indicate that a set of corresponding packets either have not arrived or have arrived out of order with respect to other packets. Based on detecting the set of skipped sequence numbers, the receiver device may trigger a reordering timer. The reordering timer may have a configurable length, which may be configured based on, among other concerns, a subcarrier spacing of a carrier(s) on which the PDCP PDUs are received. The reordering timer may be used to determine a reordering window (though the reordering window can be based on or modified by factors other than the reordering timer). For in-order delivery of PDCP PDUs, the receiver device may buffer received traffic during the reordering window. If the receiver device receives packets having the set of skipped sequence numbers in the reordering window, the receiver device may reorder packets received in the reordering window such that sequence numbers of the packets are in order (e.g., ascending order), and may provide (e.g., deliver) the reordered packets to higher layers of the UE. If the receiver device reaches the end of the reordering timer without having received the packets associated with the out-of-order set of sequence numbers, the receiver device may provide all received packets to the higher layers indicated by the set of sequence numbers (minus any unreceived packets). After the reordering timer ends, the receiver device may move the reordering window forward such that a second instance of the reordering window begins at a sequence number position a first instance of the reordering window ended. The receiver device may then discard any received packets with sequence numbers lower than a lowest sequence number of the second instance of the reordering window.

As mentioned above, when PDCP out-of-order delivery is enabled on the downlink path, packets arriving may not be subject to reordering and may be delivered to upper layers immediately. In cases where a block error rate (BLER) is observed, there may be frequent sequence number holes at the RLC and/or PDCP layers leading to many out-of-sequence packets being delivered to upper layers. This is because in out-of-order delivery (e.g., in NR), RLC full PDUs are delivered to the PDCP layer directly without waiting for HARQ retransmission of erroneous data blocks. For such radio access technologies (e.g., NR), the network typically targets a BLER of 10% for a first transmission HARQ. Furthermore, a HARQ round trip time (indicating the length of time involved in providing a HARQ negative acknowledgment and receiving a retransmission of a packet, or between detecting that the packet was missed and receiving a retransmission of the packet) may be about 5 ms. This implies that every 10 ms or less (assuming 10 HARQ processes used with a length of 1 ms each), there may be an out of order delivery lasting approximately 5 ms. This may be suitable for some low latency applications. However, some transport protocols, such as the Transport Control Protocol (TCP), may use congestion detection. A TCP receiver may identify a loss each time out of order packets are received by the TCP receiver, and the congestion control configuration of the TCP receiver may reduce the sending throughput as a result. TCP cubic, for instance, scales the throughput according to a cubic function of the time since the last loss event. If losses are frequent (such as due to frequent HARQ retransmissions occurring), TCP cubic throughput may be heavily impacted. As one example, TCP throughput can degrade by a factor of 1000 when PDCP out of order delivery is enabled with immediate delivery, as compared to PDCP in-order delivery.

Some techniques described herein provide reordering, by a receiver device, on a time scale shorter than a reordering window (or a window defined by a reordering timer). For example, the receiver device may initiate a timer upon detecting an out-of-order packet. The timer may be shorter than a reordering timer. The receiver device may accumulate out-of-order packets while the timer is running and during the reordering window. If the receiver device can successfully reorder packets within the timer so that the out-of-order packet is correctly ordered, the receiver device may provide the packets received during the timer in the correct order (e.g., may perform reordering of the packets). Otherwise, the receiver device may provide the packets out-of-order (or in-order, minus any missed packets) and/or may restart the timer. The timer may provide for reordering of packets to accommodate out-of-order conditions due to, for example, HARQ feedback at the physical layer. Furthermore, the gain of earlier delivery (when using out-of-order delivery) is maintained, which reduces the impact of long delays (such as when a PDCP PDU is lost in the core network, RLC retransmission is required, handover is performed, etc.). This provides a balance between maintenance and optimization of TCP throughput and the benefits of out of order delivery.

As shown by reference number 602, the receiver device may receive a first packet (Packet 1) associated with a first SN (SN 1). As shown by reference number 604, the receiver device may receive a second packet (Packet 2) associated with a second SN (SN 3). Thus, at least one packet (having an SN 2) was missed between Packet 1 and Packet 2. In some aspects, the receiver device may identify a hole (e.g., a gap in sequence caused by out-of-order reception of packets) due to the absence of SN 2.

As shown, the receiver device may trigger a timer 606 based at least in part on the hole. For example, the receiver device may trigger a timer 606 upon receiving the second packet (with SN 3) without having received a packet with SN 2. The timer 606 may be shorter in length than a reordering window 608. For example, the timer 606 may be shorter than a reordering timer used to define the reordering window upon detecting an out-of-order packet. In some aspects, the receiver device may trigger the timer 606 based at least in part on a traffic type of one or more of the packets. For example, the receiver device may trigger the timer 606 if the traffic type is associated with a loss-based congestion configuration (such as TCP cubic).

In some aspects, a length of the timer 606 may be configured. For example, the receiver device may receive configuration information indicating a length of the timer 606. In some aspects, the length of the timer 606 may be defined by reference to a length of the reordering window 608 (e.g., as a fraction of the length of the reordering window 608). In some aspects, the length of the timer 606 may be expressed as a number of milliseconds. In some aspects, the length of the timer 606 may be expressed in a number of transmission time intervals (TTIs), or based on the TTI (slot) duration depending on the NR numerology. In some aspects, the length of the timer 606 may be based at least in part on a HARQ round trip time of the receiver device. For example, the length of the timer 606 may be equal to a HARQ round trip time, may be greater than a HARQ round trip time, or the like. In some aspects, the receiver device may adjust the length of the timer 606 based at least in part on a HARQ operation. For example, the timer 606 may scale with a number of HARQ retransmissions of the receiver device. In some aspects, the number of HARQ retransmissions may be derived from a target (e.g., residual) BLER.

As shown by reference number 610, the receiver device may receive a third packet (Packet 3) with an SN 2. For example, the receiver device may receive the third packet while the timer 606 is running. The receiver device may buffer (e.g., store) Packet 1 and Packet 2 during the timer 606. If the receiver device receives the one or more out-of-order packets (in this example, Packet 3), the receiver device may reorder Packets 1, 2, and 3 according to SNs, and may provide the reordered packets in order to one or more upper layers, as shown by reference number 612. If the receiver device does not receive the one or more out-of-order packets within the timer 606, the receiver device may provide the packets received while the timer was running to one or more upper layers in the order in which the set of packets were received.

In some aspects, the receiver device may restart the timer 606 after the timer 606 has expired. For example, the receiver device may start a second instance of the timer 606 after a first instance of the timer 606 (triggered by the detection of the hole) has expired. In some aspects, the receiver device may trigger up to a number N instances of the timer 606. N may be configurable (e.g., the receiver device may receive information indicating a number of instances of the timer 606 that can occur, such as can occur within the reordering window 608). After N instances of the timer 606 have elapsed (and any received packets during the N instances have been provided to upper layers), the receiver device may resume operation according to the reordering window 608. For example, the PDCP entity of the UE may wait for packets associated with holes occurring before packets received during the N instances of the timer 606. If the reordering window 608 (or the reordering timer defining the reordering window 608) is stopped at any time due to expiry or packets received such that RX_DELIV (which indicates the COUNT value of the last PDCP SDU delivered to the upper layers) is at least RX_REORD (which indicates the COUNT value following the COUNT value associated with the PDCP Data PDU which triggered the reordering window 608), the receiver device may stop the timer 606 (if it is running) and provide the accumulated packets to upper layers.

As shown by reference number 614, the receiver device may provide a remainder of packets received in the reordering window 608 to one or more upper layers. For example, using in-order delivery, the receiver device may provide the remainder of packets in order of sequence number (if reordering is successful) or in an order indicated by the set of sequence numbers (minus any unreceived packets) (if reordering is unsuccessful). As another example, using out-of-order delivery, the receiver device may provide the remainder of packets in an order in which the remainder of packets are received.

To illustrate, as a first example, the packets received in the reordering window 608 may omit a fourth packet (e.g., the fourth packet may not be received). The receiver device may provide the remainder of packets after an end of the reordering window 608 based at least in part on having not received the fourth packet within the reordering window 608. In some aspects, the receiver device may trigger a second instance of the timer 606 based at least in part on detecting the omission of the fourth packet (e.g., detecting a hole corresponding to the fourth packet).

To illustrate, as a second example, the packets received in the reordering window 608 may include a fourth packet with a fourth sequence number that is higher than a fifth sequence number of a fifth packet received after the fourth packet. The receiver device may provide the remainder of packets in an order according to sequence numbers of the remainder of packets (e.g., using in order delivery).

To illustrate, as a third example, the packets received in the reordering window 608 may include a fourth packet with a fourth sequence number that is higher than a fifth sequence number of a fifth packet received after the fourth packet. The receiver device may provide the remainder of packets in an order in which the remainder of packets are received (e.g., using out of order delivery).

As indicated above, FIG. 6 is provided as an example. Other examples may differ from what is described with regard to FIG. 6.

FIG. 7 is a diagram illustrating an example process 700 performed, for example, by a receiver device, in accordance with the present disclosure. Example process 700 is an example where the receiver device (e.g., UE 120, network node 110) performs operations associated with techniques for PDCP ordering.

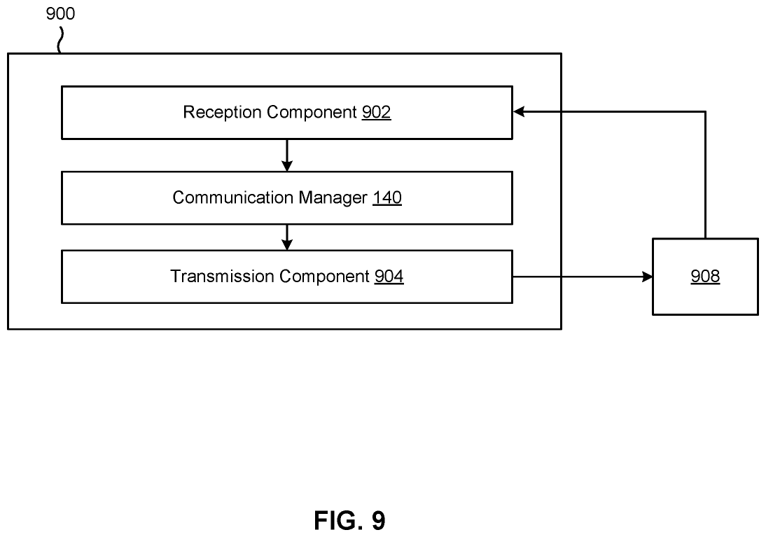

As shown in FIG. 7, in some aspects, process 700 may include receiving a first packet of a plurality of packets at a first time, wherein the first packet has a first sequence number (block 710). For example, the receiver device (e.g., using reception component 902 and/or communication manager 906, depicted in FIG. 9) may receive a first packet of a plurality of packets at a first time, wherein the first packet has a first sequence number, as described above.

As further shown in FIG. 7, in some aspects, process 700 may include receiving a second packet of the plurality of packets at a second time, wherein a third packet of the plurality of packets, to be received between the first packet and the second packed based at least in part on a third sequence number of the third packet, has not arrived at the second time (block 720). For example, the receiver device (e.g., using reception component 902 and/or communication manager 906, depicted in FIG. 9) may receive a second packet of the plurality of packets at a second time, wherein a third packet of the plurality of packets, to be received between the first packet and the second packed based at least in part on a third sequence number of the third packet, has not arrived at the second time, as described above.

As further shown in FIG. 7, in some aspects, process 700 may include starting a timer based at least in part on the third packet having not arrived at the second time (block 730). For example, the receiver device (e.g., using communication manager 906, depicted in FIG. 9) may start a timer based at least in part on the third packet having not arrived at the second time, as described above.

As further shown in FIG. 7, in some aspects, process 700 may include receiving the third packet of the plurality of packets at a third time after the second time (block 740). For example, the receiver device (e.g., using reception component 902 and/or communication manager 906, depicted in FIG. 6) may receive the third packet of the plurality of packets at a third time after the second time, as described above.

As further shown in FIG. 7, in some aspects, process 700 may include providing the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer (block 750). For example, the receiver device (e.g., using communication manager 906, depicted in FIG. 9) may provide the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer, as described above.

Process 700 may include additional aspects, such as any single aspect or any combination of aspects described below and/or in connection with one or more other processes described elsewhere herein.

In a first aspect, the timer is shorter than a length of the reordering window.

In a second aspect, alone or in combination with the first aspect, process 700 includes providing a remainder of packets, of the plurality of packets other than the first packet, the second packet, and the third packet, to the higher layer.

In a third aspect, alone or in combination with one or more of the first and second aspects, the plurality of packets omits a fourth packet, and wherein providing the remainder of packets further comprises providing the remainder of packets after an end of the reordering window based at least in part on having not received the fourth packet within the reordering window.

In a fourth aspect, alone or in combination with one or more of the first through third aspects, the omission of the fourth packet triggers a second instance of the timer.

In a fifth aspect, alone or in combination with one or more of the first through fourth aspects, the plurality of packets includes a fourth packet with a fourth sequence number that is higher than a fifth sequence number of a fifth packet received after the fourth packet, and wherein providing the remainder of packets further comprises providing the remainder of packets including the fourth packet after the fifth packet.

In a sixth aspect, alone or in combination with one or more of the first through fifth aspects, the plurality of packets includes a fourth packet with a fourth sequence number that is higher than a fifth sequence number of a fifth packet received after the fourth packet, and wherein providing the remainder of packets further comprises providing the remainder of packets including the fourth packet in a position in which the fourth packet was received.

In a seventh aspect, alone or in combination with one or more of the first through sixth aspects, process 700 includes receiving information indicating a number of instances of the timer that can occur within the reordering window.

In an eighth aspect, alone or in combination with one or more of the first through seventh aspects, process 700 includes starting the timer and the reordering window based at least in part on detecting that the third packet is out of order.

In a ninth aspect, alone or in combination with one or more of the first through eighth aspects, process 700 includes starting the timer based at least in part on a traffic type of one or more of the plurality of packets.

In a tenth aspect, alone or in combination with one or more of the first through ninth aspects, the traffic type is associated with a loss-based congestion configuration.

In an eleventh aspect, alone or in combination with one or more of the first through tenth aspects, a length of the timer is based at least in part on a hybrid automatic repeat request round trip time of the receiver device.

In a twelfth aspect, alone or in combination with one or more of the first through eleventh aspects, a length of the timer is based at least in part on a number of hybrid automatic repeat request retransmissions of the receiver device.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a receiver device, in accordance with the present disclosure. Example process 800 is an example where the receiver device (e.g., UE 120, network node 110) performs operations associated with techniques for PDCP ordering.

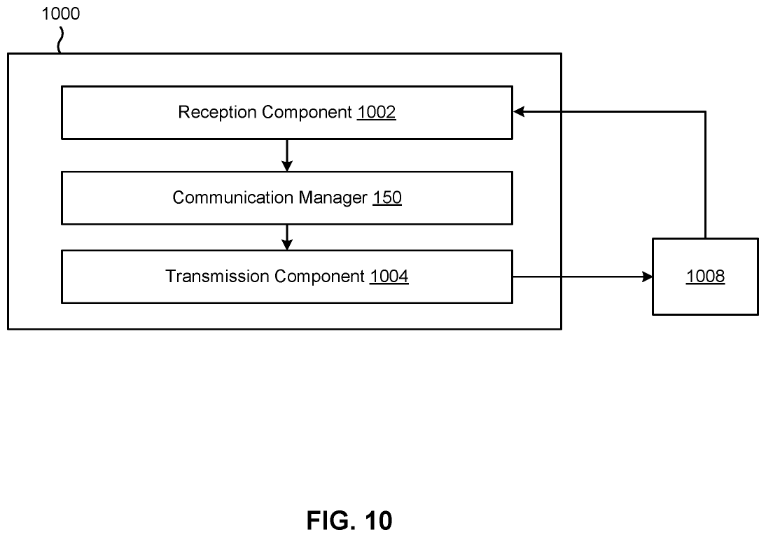

As shown in FIG. 8, in some aspects, process 800 may include receiving a first packet of a set of packets at a first time, the first packet having a first sequence number, wherein the set of packets is associated with a respective set of sequence numbers including a highest sequence number and the receiver device is configured for in-order delivery of packets (block 810). For example, the receiver device (e.g., using communication manager 150 and/or reception component 1004, depicted in FIG. 10) may receive a first packet of a set of packets at a first time, the first packet having a first sequence number, wherein the set of packets is associated with a respective set of sequence numbers including a highest sequence number and the receiver device is configured for in-order delivery of packets, as described above.

As further shown in FIG. 8, in some aspects, process 800 may include receiving a second packet of the set of packets at a second time, the second packet having a second sequence number (block 820). For example, the receiver device (e.g., using communication manager 150 and/or reception component 1002, depicted in FIG. 10) may receive a second packet of the set of packets at a second time, the second packet having a second sequence number, as described above.

As further shown in FIG. 8, in some aspects, process 800 may include providing the first packet and the second packet based at least in part on expiration of a reordering timer (block 830). For example, the receiver device (e.g., using communication manager 150, depicted in FIG. 10) may receive a third packet of the set of packets at a third time, the third packet having a third sequence number that is between the first sequence number and the second sequence number, and wherein the third packet is received within a threshold range of the highest sequence number, as described above

As further shown in FIG. 8, in some aspects, process 800 may include receiving a third packet of the set of packets at a third time, the third packet having a third sequence number that is between the first sequence number and the second sequence number, and wherein the third packet is received within a threshold range of the highest sequence number (block 830). For example, the receiver device (e.g., using communication manager 150 and/or reception component 1002, depicted in FIG. 10) may receive a third packet of the set of packets at a third time, the third packet having a third sequence number that is between the first sequence number and the second sequence number, and wherein the third packet is received within a threshold range of the highest sequence number, as described above.

As further shown in FIG. 8, in some aspects, process 800 may include providing the third packet based at least in part on the third packet being received within the threshold range of the highest sequence number (block 840). For example, the receiver device (e.g., using communication manager 150) may provide the third packet based at least in part on the third packet being received within the threshold range of the highest sequence number, as described above.

Process 800 may include additional aspects, such as any single aspect or any combination of aspects described below and/or in connection with one or more other processes described elsewhere herein.

In a first aspect, process 800 includes receiving configuration information indicating that delivery of the third packet if the third packet is received within the threshold range of the highest sequence number is enabled.

In a second aspect, alone or in combination with the first aspect, providing the third packet further comprises providing the third packet based at least in part on the third packet being received between a packet with a sequence number of the highest sequence number minus the threshold range and a packet with the highest sequence number.

In a third aspect, alone or in combination with one or more of the first and second aspects, the threshold range indicates a number of packets.

In a fourth aspect, alone or in combination with one or more of the first through third aspects, receiving the third packet further comprises receiving the third packet prior to a packet, of the set of packets, with the highest sequence number and after a packet, of the set of packets, that is separated from the packet with the highest sequence number by fewer than the number of packets.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a receiver device, or a receiver device may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908 (such as a UE, a base station, or another wireless communication device) using the reception component 902 and the transmission component 904.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the receiver device described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the receiver device described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the receiver device described in connection with FIG. 2. In some aspects, the transmission component 904 may be co-located with the reception component 902 in a transceiver.

The reception component 902 may receive a first packet of a plurality of packets at a first time, wherein the first packet has a first sequence number. The reception component 902 may receive a second packet of the plurality of packets at a second time, wherein a third packet of the plurality of packets, to be received between the first packet and the second packed based at least in part on a third sequence number of the third packet, has not arrived at the second time. The communication manager 906 may start a timer based at least in part on the third packet having not arrived at the second time. The reception component 902 may receive the third packet of the plurality of packets at a third time after the second time. The communication manager 906 may provide the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

The communication manager 906 may provide a remainder of packets, of the plurality of packets other than the first packet, the second packet, and the third packet, to the higher layer.

The reception component 902 may receive information indicating a number of instances of the timer that can occur within the reordering window.

The communication manager 906 may start the timer and the reordering window based at least in part on detecting that the third packet is out of order.

The communication manager 906 may start the timer based at least in part on a traffic type of one or more of the plurality of packets.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a receiver device, or a receiver device may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008 (such as a UE, a base station, or another wireless communication device) using the reception component 1002 and the transmission component 1004.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the receiver device described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the receiver device described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the receiver device described in connection with FIG. 2. In some aspects, the transmission component 1004 may be co-located with the reception component 1002 in a transceiver.

The reception component 1002 may receive a first packet of a set of packets at a first time, the first packet having a first sequence number, wherein the set of packets is associated with a respective set of sequence numbers including a highest sequence number and the receiver device is configured for in-order delivery of packets. The reception component 1002 may receive a second packet of the set of packets at a second time, the second packet having a second sequence number. The reception component 1002 may receive a third packet of the set of packets at a third time, the third packet having a third sequence number that is between the first sequence number and the second sequence number, and wherein the third packet is received within a threshold range of the highest sequence number. The communication manager 1006 may provide the third packet based at least in part on the third packet being received within the threshold range of the highest sequence number.

The reception component 1002 may receive configuration information indicating that delivery of the third packet if the third packet is received within the threshold range of the highest sequence number is enabled.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a receiver device, comprising: receiving a first packet of a plurality of packets at a first time, wherein the first packet has a first sequence number; receiving a second packet of the plurality of packets at a second time, wherein a third packet of the plurality of packets, to be received between the first packet and the second packed based at least in part on a third sequence number of the third packet, has not arrived at the second time; starting a timer based at least in part on the third packet having not arrived at the second time; receiving the third packet of the plurality of packets at a third time after the second time; and providing the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

Aspect 2: The method of Aspect 1, wherein the timer is shorter than a length of a reordering timer.

Aspect 3: The method of any of Aspects 1-2, further comprising providing a remainder of packets, of the plurality of packets other than the first packet, the second packet, and the third packet, to the higher layer.

Aspect 4: The method of Aspect 3, wherein the plurality of packets omits a fourth packet, and wherein providing the remainder of packets further comprises providing the remainder of packets after an end of a reordering timer based at least in part on having not received the fourth packet within the reordering timer.

Aspect 5: The method of Aspect 4, wherein the omission of the fourth packet triggers a second instance of the timer.

Aspect 6: The method of Aspect 3, wherein the plurality of packets includes a fourth packet with a fourth sequence number that is higher than a fifth sequence number of a fifth packet received after the fourth packet, and wherein providing the remainder of packets further comprises providing the remainder of packets including the fourth packet after the fifth packet.

Aspect 7: The method of Aspect 3, wherein the plurality of packets includes a fourth packet with a fourth sequence number that is higher than a fifth sequence number of a fifth packet received after the fourth packet, and wherein providing the remainder of packets further comprises providing the remainder of packets including the fourth packet in a position in which the fourth packet was received.

Aspect 8: The method of any of Aspects 1-7, further comprising receiving information indicating a number of instances of the timer that can occur within a reordering timer.

Aspect 9: The method of any of Aspects 1-8, further comprising starting the timer and a reordering timer based at least in part on detecting that the third packet is out of order.

Aspect 10: The method of any of Aspects 1-9, further comprising starting the timer based at least in part on a traffic type of one or more of the plurality of packets.

Aspect 11: The method of Aspect 10, wherein the traffic type is associated with a loss-based congestion configuration.

Aspect 12: The method of any of Aspects 1-11, wherein a length of the timer is based at least in part on a hybrid automatic repeat request round trip time of the receiver device.

Aspect 13: The method of any of Aspects 1-12, wherein a length of the timer is based at least in part on a number of hybrid automatic repeat request retransmissions of the receiver device.

Aspect 14: A method of wireless communication performed by a receiver device, comprising: receiving a first packet of a set of packets at a first time, the first packet having a first sequence number, wherein the set of packets is associated with a respective set of sequence numbers including a highest sequence number and the receiver device is configured for in-order delivery of packets; receiving a second packet of the set of packets at a second time, the second packet having a second sequence number; providing the first packet and the second packet based at least in part on expiration of a reordering timer; receiving a third packet of the set of packets at a third time, the third packet having a third sequence number that is between the first sequence number and the second sequence number, and wherein the third packet is received within a threshold range of the highest sequence number; and providing the third packet based at least in part on the third packet being received within the threshold range of the highest sequence number.

Aspect 15: The method of Aspect 14, further comprising receiving configuration information indicating that delivery of the third packet if the third packet is received within the threshold range of the highest sequence number is enabled.

Aspect 16: The method of any of Aspects 14-15, wherein providing the third packet further comprises providing the third packet based at least in part on the third packet being received between a packet with a sequence number of the highest sequence number minus the threshold range and a packet with the highest sequence number.

Aspect 17: The method of any of Aspects 14-16, wherein the threshold range indicates a number of packets.

Aspect 18: The method of Aspect 17, wherein receiving the third packet further comprises: receiving the third packet prior to a packet, of the set of packets, with the highest sequence number and after a packet, of the set of packets, that is separated from the packet with the highest sequence number by fewer than the number of packets.

Aspect 19: An apparatus for wireless communication at a device, comprising a processor; memory coupled with the processor; and instructions stored in the memory and executable by the processor to cause the apparatus to perform the method of one or more of Aspects 1-13.

Aspect 20: A device for wireless communication, comprising a memory and one or more processors coupled to the memory, the one or more processors configured to perform the method of one or more of Aspects 1-13.

Aspect 21: An apparatus for wireless communication, comprising at least one means for performing the method of one or more of Aspects 1-13.

Aspect 22: A non-transitory computer-readable medium storing code for wireless communication, the code comprising instructions executable by a processor to perform the method of one or more of Aspects 1-13.

Aspect 23: A non-transitory computer-readable medium storing a set of instructions for wireless communication, the set of instructions comprising one or more instructions that, when executed by one or more processors of a device, cause the device to perform the method of one or more of Aspects 1-13.

Aspect 24: An apparatus for wireless communication at a device, comprising a processor; memory coupled with the processor; and instructions stored in the memory and executable by the processor to cause the apparatus to perform the method of one or more of Aspects 14-18.

Aspect 25: A device for wireless communication, comprising a memory and one or more processors coupled to the memory, the one or more processors configured to perform the method of one or more of Aspects 14-18.

Aspect 26: An apparatus for wireless communication, comprising at least one means for performing the method of one or more of Aspects 14-18.

Aspect 27: A non-transitory computer-readable medium storing code for wireless communication, the code comprising instructions executable by a processor to perform the method of one or more of Aspects 14-18.

Aspect 28: A non-transitory computer-readable medium storing a set of instructions for wireless communication, the set of instructions comprising one or more instructions that, when executed by one or more processors of a device, cause the device to perform the method of one or more of Aspects 14-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a receiver device, comprising:
receiving a first packet of a plurality of packets at a first time, wherein the first packet has a first sequence number;
receiving a second packet of the plurality of packets at a second time, wherein a third packet of the plurality of packets, to be received between the first packet and the second packed based at least in part on a third sequence number of the third packet, has not arrived at the second time;
starting a timer based at least in part on the third packet having not arrived at the second time;
receiving the third packet of the plurality of packets at a third time after the second time; and
providing the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

2. The method of claim 1, further comprising providing a remainder of packets, of the plurality of packets other than the first packet, the second packet, and the third packet, to the higher layer.

3. The method of claim 2, wherein the plurality of packets omits a fourth packet, and wherein providing the remainder of packets further comprises providing the remainder of packets after an end of a reordering timer based at least in part on having not received the fourth packet within the reordering timer.

4. The method of claim 3, wherein the omission of the fourth packet triggers a second instance of the timer.

5. The method of claim 2, wherein the plurality of packets includes a fourth packet with a fourth sequence number that is higher than a fifth sequence number of a fifth packet received after the fourth packet, and wherein providing the remainder of packets further comprises providing the remainder of packets including the fourth packet after the fifth packet.

6. The method of claim 2, wherein the plurality of packets includes a fourth packet with a fourth sequence number that is higher than a fifth sequence number of a fifth packet received after the fourth packet, and wherein providing the remainder of packets further comprises providing the remainder of packets including the fourth packet in a position in which the fourth packet was received.

7. The method of claim 1, wherein the timer is shorter than a length of a reordering timer.

8. The method of claim 1, further comprising receiving information indicating a number of instances of the timer that can occur within a reordering timer.

9. The method of claim 1, further comprising starting the timer and a reordering timer based at least in part on detecting that the third packet is out of order.

10. The method of claim 1, further comprising starting the timer based at least in part on a traffic type of one or more of the plurality of packets.

11. The method of claim 10, wherein the traffic type is associated with a loss-based congestion configuration.

12. The method of claim 1, wherein a length of the timer is based at least in part on a hybrid automatic repeat request round trip time of the receiver device.

13. The method of claim 1, wherein a length of the timer is based at least in part on a number of hybrid automatic repeat request retransmissions of the receiver device.

14. A receiver device for wireless communication, comprising:
a memory; and
one or more processors, coupled to the memory, configured to:
receive a first packet of a plurality of packets at a first time, wherein the first packet has a first sequence number;
receive a second packet of the plurality of packets at a second time, wherein a third packet of the plurality of packets, to be received between the first packet and the second packed based at least in part on a third sequence number of the third packet, has not arrived at the second time;
start a timer based at least in part on the third packet having not arrived at the second time;
receive the third packet of the plurality of packets at a third time after the second time; and
provide the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

15. The receiver device of claim 14, wherein the one or more processors are further configured to provide a remainder of packets, of the plurality of packets other than the first packet, the second packet, and the third packet, to the higher layer.

16. The receiver device of claim 15, wherein the plurality of packets omits a fourth packet, and wherein the one or more processors, to provide the remainder of packets, are configured to provide the remainder of packets after an end of a reordering timer based at least in part on having not received the fourth packet within the reordering timer.

17. The receiver device of claim 16, wherein the omission of the fourth packet triggers a second instance of the timer.

18. The receiver device of claim 15, wherein the plurality of packets includes a fourth packet with a fourth sequence number that is higher than a fifth sequence number of a fifth packet received after the fourth packet, and wherein the one or more processors, to provide the remainder of packets, are configured to provide the remainder of packets including the fourth packet after the fifth packet.

19. The receiver device of claim 15, wherein the plurality of packets includes a fourth packet with a fourth sequence number that is higher than a fifth sequence number of a fifth packet received after the fourth packet, and wherein the one or more processors, to provide the remainder of packets, are configured to provide the remainder of packets including the fourth packet in a position in which the fourth packet was received.

20. The receiver device of claim 14, wherein the timer is shorter than a length of a reordering timer.

21. The receiver device of claim 14, wherein the one or more processors are further configured to receive information indicating a number of instances of the timer that can occur within a reordering timer.

22. The receiver device of claim 14, wherein the one or more processors are further configured to start the timer and a reordering timer based at least in part on detecting that the third packet is out of order.

23. The receiver device of claim 14, wherein the one or more processors are further configured to start the timer based at least in part on a traffic type of one or more of the plurality of packets.

24. The receiver device of claim 23, wherein the traffic type is associated with a loss-based congestion configuration.

25. The receiver device of claim 14, wherein a length of the timer is based at least in part on a hybrid automatic repeat request round trip time of the receiver device.

26. The receiver device of claim 14, wherein a length of the timer is based at least in part on a number of hybrid automatic repeat request retransmissions of the receiver device.

27. A non-transitory computer-readable medium storing a set of instructions for wireless communication, the set of instructions comprising:
one or more instructions that, when executed by one or more processors of a receiver device, cause the receiver device to:
receive a first packet of a plurality of packets at a first time, wherein the first packet has a first sequence number;
receive a second packet of the plurality of packets at a second time, wherein a third packet of the plurality of packets, to be received between the first packet and the second packed based at least in part on a third sequence number of the third packet, has not arrived at the second time;
start a timer based at least in part on the third packet having not arrived at the second time;
receive the third packet of the plurality of packets at a third time after the second time; and
provide the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

28. The non-transitory computer-readable medium of claim 27, wherein the one or more instructions further cause the one or more processors to provide a remainder of packets, of the plurality of packets other than the first packet, the second packet, and the third packet, to the higher layer.

29. An apparatus, comprising:
means for receiving a first packet of a plurality of packets at a first time, wherein the first packet has a first sequence number;
means for receiving a second packet of the plurality of packets at a second time, wherein a third packet of the plurality of packets, to be received between the first packet and the second packed based at least in part on a third sequence number of the third packet, has not arrived at the second time;
means for starting a timer based at least in part on the third packet having not arrived at the second time;
means for receiving the third packet of the plurality of packets at a third time after the second time; and
means for providing the first packet, the second packet, and the third packet in an order based at least in part on whether the third packet is received within the timer, wherein the third packet is provided between the first packet and the second packet if the third packet is received within the timer, and wherein the third packet is provided after the second packet if the third packet is not received within the timer.

30. The apparatus of claim 29, further comprising means for providing a remainder of packets, of the plurality of packets other than the first packet, the second packet, and the third packet, to the higher layer.
